(19) United States
(12) Patent Application Publication
(10) Pub. No.: US 2007/0043848 A1
(43) Pub. Date: Feb. 22, 2007

(54) Method and system for selective control of mms service in well defined premises

(75) Inventors: Sock Hiang Sing, Singapore (SG); Keng Chuah Tan, Singapore (SG); Yong Soon Sim, Singapore (SG); Kwai Yoke Lim, Singapore (SG); Siew Eng Lim, Singapore (SG)

Correspondence Address: LAWRENCE Y.D. HO & ASSOCIATES PTE LTD, 30 BIDEFORD ROAD, #07-01, THONGSIA BUILDING, SINGAPORE, 229922, SG

(73) Assignee: NANYANG POLYTECHNIC, SINGAPORE (SG)

(21) Appl. No.: 10/555,449

(22) PCT Filed: Apr. 22, 2004
(86) PCT No.: PCT/SG04/00104

§ 371 Date: Nov. 3, 2005

(30) Foreign Application Priority Data
Jul. 3, 2003 (SG) 200304019-3

(51) Int. Cl. G06F 15/173

(52) U.S. Cl. 709/224

(57) ABSTRACT

A method for restricting usage of a mobile communicator in a well defined area, the method comprising: monitoring protocol signals between the mobile communicator and a mobile communicator network, the mobile communicator in communication with the mobile communication network for MMS services; determining MMS capability of the mobile communicator, and contacting the mobile communicator network to disable access of the mobile communicator to an MMS server in communication with the mobile communicator network.

### FIELD OF THE INVENTION

The present invention generally relates to multi-media messaging (MMS) services. In particular, the invention relates to a method and system for selective control of MMS service in well defined premises.

### BACKGROUND OF THE INVENTION

MMS messaging is a new avenue for transmitting data from one mobile phone to a receiving device which can be another mobile phone or even an email account This MMS messaging allows one user to send media filled data in a message over the mobile phone networks to his desired destination.

With new models of mobile phones being developed, this MMS feature is fast becoming a standard feature to be found in most mobile phones. An additional feature that has recently been introduced is that of the built in camera Some examples of Mobile phones with this feature are Nokia 7250 and Samsung SGH-V200 both have built in digital cameras in addition to their MMS transmitting and receiving capabilities.

These “Camera Phones” have however began to pose a security threat. In high restricted facilities such as military installations and research labs, use of such camera phones have begun to be banned. The concern is that of an intentional acquiring of prohibited or highly confidential information by users of these camera phones and a rapid dissemination of the acquired information to another user. The transmission of such information via MMS is so rapid that interception of the transmission is almost impossible.

Conventional methods would simply be to jam all mobile communication signals in the restricted facility. However, this also prevents legitimate use of mobile phones in the restricted facility and may also run foul of communication protocols of regulatory bodies.

Alternative methods would be to physically search and confiscate camera phones being carried into restricted facilities. This however may not be effective if the camera phones are well hidden.

It can thus be seen that present methods for control of MMS services are inadequate and a need for a better method exists.

### SUMMARY OF THE INVENTION

The present invention seeks to provide a method and system for control of MMS service in a well defined premise.

Accordingly, in one aspect, the present invention provides, a method for restricting usage of a mobile communicator in a well defined premise, the method comprising: monitoring protocol signals between the mobile communicator and a mobile communicator network, the mobile communicator in communication with the mobile communication network; determining MMS capability of the mobile communicator; and contacting the mobile communicator network to disable access of the mobile communicator to MMS service.

In another aspect, the present invention provides, a system for restricting usage of a mobile communicator in a well defined premise, the system comprising: a protocol monitoring device for monitoring protocol signals between a mobile communicator and a mobile communicator network; a security server coupled to the protocol monitoring device, the security server adapted for processing data from the protocol monitoring device and having communication means for communicating with the mobile communicator network; wherein the security server upon determining the mobile communicator possessing MMS capabilities, communicates with the mobile communicator network via the communicating means, instructing the mobile communication network to disable MMS service to the mobile communicator.

### BRIEF DESCRIPTION OF THE DRAWINGS

A preferred embodiment of the present invention will now be more fully described, with reference to the drawings of which:

FIG. 1 illustrates a system for control of MMS service in accordance with the present invention;

FIG. 2 illustrates a flowchart of a method in accordance with the present invention; and

FIG. 3 illustrates a flowchart of the determining step of FIG. 1.

### DETAILED DESCRIPTION OF THE DRAWINGS

A method and system for selective control of MMS service in well defined premises with a preferred embodiment is described. In the following description, details are provided to describe the preferred embodiment It shall be apparent to one skilled in the art, however that the invention may be practiced without such details. Some of the details may not be described at length so as not to obscure the invention.

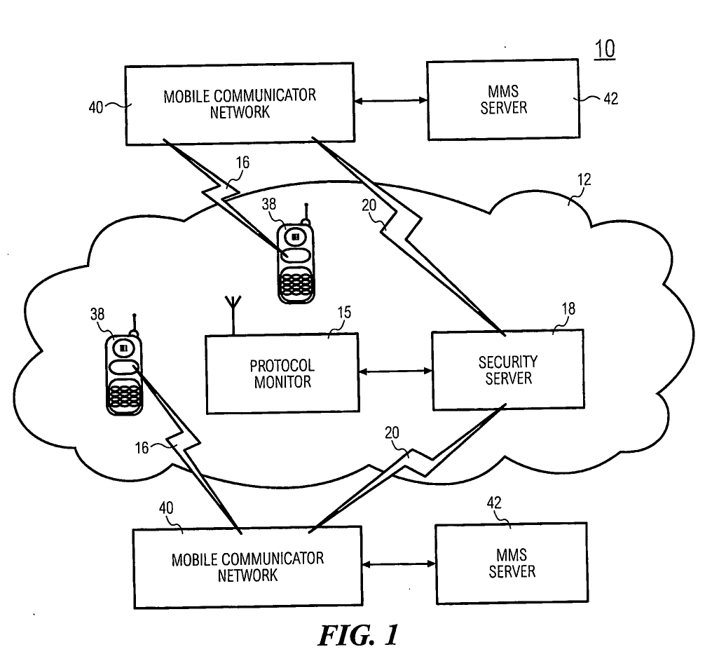

Referring to FIG. 1, the system in accordance with the present invention comprise a protocol monitor or a protocol monitoring device 15 and a security server 18. The protocol monitoring device 15 is for monitoring protocol signals 16 between at least one mobile communicator 38 and a mobile communicator network 40 when the mobile communicator 38 is within the perimeter of a well defined premise 12.

The security server 18 is coupled to and receives data from the protocol monitoring device 15. The protocol monitoring device 15 is adapted to retrieve the International Mobile Equipment Identifier (IMEI) number of the mobile communicator 38 from the protocol signals 16 being monitored. This IMEI number is then sent to the security server which processes the IMMI number and identifies the model of the mobile communicator 38. The security server is further adapted to retrieve an IMEI sequence from the IMEI number that identifies the model of the mobile communicator 38. The mobile communicator 38 could very well be a mobile phone, an example of which is a Samsung SGH V-200 “Camera Phone”.

With the model of the mobile communicator 38 identified, the model could be compared with a database of MMS capable mobile communicators to determine the MMS capability of the mobile communicator 38. The database may well reside in the security server and may be referred to as the security server 18 database.

The security server 18 is further in communication with the mobile communicator network 40 via a communication means 20. When an MMS capable mobile communicator 38 is identified to be within the well defined premise 12, the security server 18 communicates with the mobile communicator network 40 and instructs the mobile communicator network 40 to disable MMS services to that mobile communicator 38. The mobile communicator network 40 upon receiving instructions from the security server 18 further instructs an MMS server 42 in communication with the mobile communicator network 40 not to extend any MMS services to the mobile communicator 38 until further instructed. The mobile communicator network 40 either prevents the mobile communicator 38 from accessing the MMS server 42 or to instruct the MMS server to not respond to the mobile communicator's 38 requests for MMS service.

This disablement of MMS service is temporary and is only effective while the mobile communicator 38 is within the well defined premise 12. Furthermore, the other services available to the mobile communicator are not affected, and services such as voice communication, Short Messaging Service (SMS) and voice mail may still be available.

The security server 18 in communication with the mobile communicator network 40 may further track the location of the mobile communicator 38 via known tracking methods such as triangulation or forced handovers within the mobile communicator network 40. Once the mobile communicator 38 has left the well defined premise 12, the security server would then communicate with the mobile communicator network 40 to restore MMS service.

The protocol monitoring device 15 may also be used to track the locations of the mobile communicator 38. The protocol monitoring device 15 may be adapted to have a predetermined range whereby it can monitor protocol signals of mobile communicators 38 only in a predetermined range. This predetermined range may be the perimeters of the well defined premise 12. Once outside this predetermined range, it may be deemed that the mobile communicator 38 has left the well defined premise 12 and MMS service may now be restored.

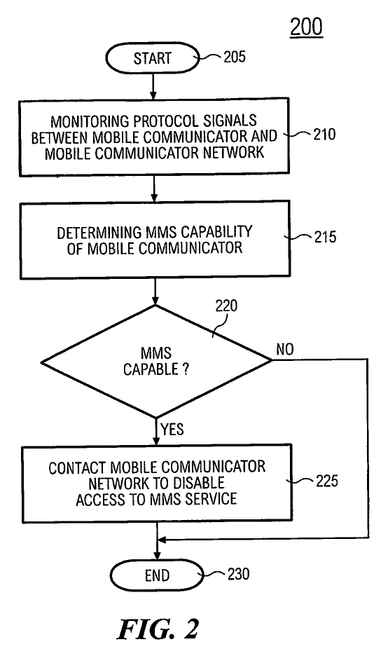

Referring to FIG.2 and FIG. 1, the method 200 for selective control of MMS service in well defined premises starts with the step of monitoring 210 protocol signals between the mobile communicator 38 and the mobile communicator network 40. Next, the step of determining 215 MMS capability of the mobile communicator 38 is performed. If the mobile communicator 38 is MMS capable 220, the mobile communicator network is contacted 225 to disable the mobile communicator's access to MMS service. The mobile communicator network 40 is in communication with a MMS server 42 which provides the MMS service to the mobile communicators 38. The mobile communicator network 40 either prevents the mobile communicator 38 from accessing the MMS server 42 or to instruct the MMS server not to respond to the mobile communicator's 38 requests for MMS service.

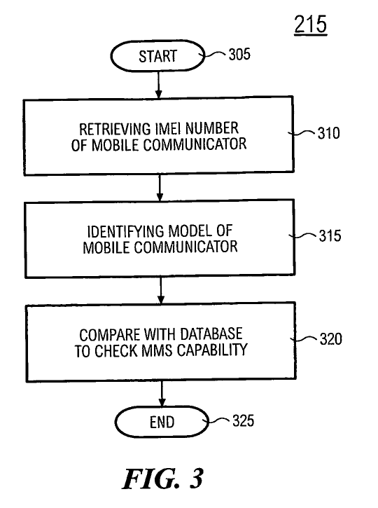

Referring to FIG. 3, the step for determining 215 the MMS capability of the mobile communicator 38 further comprises the step of retrieving 310 the IMEI number of the mobile communicator 38 from the protocol signals between the mobile communicator 38 and the mobile communicator network 40. Next, the step of identifying 315 the model of the mobile communicator 38 from the IMEI number is performed: A portion or a particular sequence of the IMEI number is for identifying the model of the mobile communicator 38.

In the identifying 315 step, the particular sequence identifying the model of the mobile communicator 38 is retrieved and compared with a look up table so that the model of the mobile communicator can be ascertained. The retrieving of the particular sequence of the IMEI number and the comparing with the look up table may be performed by the security server 18 coupled to the protocol monitoring device 15.

Next, the step of comparing 320 the model of the mobile communicator 38 with a security server 18 database to check the MMS capability of the mobile communicator 38. The security server 18 database comprises a list of IMEI sequences for models of mobile communicators 38 having MMS capabilities. If the sequence of the IMEI retrieved matches any of the IMEI sequences in the database, then the mobile communicator 38 is deemed to be MMS capable.

This security server 18 database may be updated regularly to anticipate new models of mobile communicators 38 having MMS capabilities appearing on the market. Furthermore, in the event that the IMEI number or sequence retrieved is not recognized or if the security server 18 is unable to determine the MMS capability of the mobile communicator, then the security server 18 would nonetheless contact and instruct the mobile communicator network 40 to disable the MMS service for the mobile communicator 38.

It will be appreciated that various modifications and improvements can be made by a person skilled in the art without departing from the scope of the present invention.

1. A method for restricting usage of a mobile communicator in a well defined premise, said method comprising:
a. monitoring protocol signals between said mobile communicator and a mobile communicator network, said mobile communicator in communication with said mobile communication network;
b. determining MMS capability of said mobile communicator; and
c. contacting said mobile communicator network to disable access of said mobile communicator to MMS service.

2. The method in accordance with claim 1, wherein said step b. further comprises:
i. retrieving IMEI number of said mobile communicator;
ii. identifying said model of said mobile communicator from said IMEI number by comparing with a look up table of models of mobile communicators; and
iii. comparing said model of said mobile communicator with a database of MMS capable mobile communicators to check MMS capability of said mobile communicator.

3. The method in accordance with claim 2, wherein said step ii. Further comprises:
1. retrieving particular sequence of said IMEI number for identifying model of said mobile communicator; and
2. comparing with a look up table to ascertain model of said mobile communicator.

4. The method in accordance with claim 1, wherein said step c. further comprises: instructing an MMS server for providing MMS service to ignore requests for MMS service from said mobile communicator, said MMS server is in communication with said mobile communicator network

5. The method in accordance with claim 1, wherein said step c. further comprises: preventing said mobile communicator from accessing an MMS server for providing MMS service and in communication with said mobile communicator network.

6. The method in accordance with claim 1, wherein said step a is performed by a protocol monitoring device.

7. The method in accordance with claim 6, wherein said step b. and step c. are performed by a security server coupled to said protocol monitoring device.

8. A system for restricting usage of a mobile communicator in a well defined premise, said system comprising:
a protocol monitoring device for monitoring protocol signals between a mobile communicator and a mobile communicator network;
a security server coupled to said protocol monitoring device, said security server adapted for processing data from said protocol monitoring device and having communication means for communicating with said mobile communicator network;
wherein said security server upon determining said mobile communicator possessing MMS capabilities, communicates with said mobile communicator network via said communicating means, instructing said mobile communication network to disable MMS service to said mobile communicator.

9. The system in accordance with claim 8, wherein said data comprises an IMEI number of said mobile communicator.

10. The system in accordance with claim 9, wherein said protocol monitoring device is adapted for retrieving said IMEI number of said mobile communicator from said protocol signals.

11. The system in accordance with claim 9, wherein said security server is adapted to identify model of said mobile communicator by comparing a sequence of said IMEI number to a look up table comprising models of mobile communicators.

12. The system in accordance with claim 11, wherein said security server is further adapted to determine MMS capabilities of said mobile communicator by referencing said model of said mobile communicator and comparing with a database of models of MMS capable mobile communicators.

13. The system in accordance with claim 8, wherein said mobile communicator network is in communication with an MMS server for providing MMS service to said mobile communicator.

14. The system in accordance with claim 13, wherein said mobile communicator network disables MMS service to said mobile communicator by instructing said MMS server to ignore requests for MMS service from said mobile communicator.

15. The system in accordance with claim 13, wherein said mobile communicator network disable MMS service to said mobile communicator by preventing said mobile communicator from accessing said MMS server.
